(19) United States
(12) Patent Application Publication
(10) Pub. No.: US 2020/0300818 A1
(43) Pub. Date: Sep. 24, 2020

(54) HIGH-FREQUENCY OSCILLATORY PLASTIC DEFORMATION BASED SOLID-STATE MATERIAL DEPOSITION FOR METAL SURFACE REPAIR

(71) Applicant: University of Louisville Research Foundation, Inc., Louisville, KY (US)

(72) Inventors: Keng Hsu, Louisville (US); Anagh Deshpande, Louisville (US)

(73) Assignee: University of Louisville Research Foundation, Inc., Louisville, KY (US)

(21) Appl. No.: 16/822,341

(22) Filed: Mar. 18, 2020

Related U.S. Application Data
(60) Provisional application No. 62/821,228, filed on Mar. 20, 2019.

(51) Int. Cl. G01N 29/28; G01N 29/34; B23K 1/005

(52) U.S. Cl. CPC G01N 29/28; G01N 29/348; G01N 2291/0234; G01N 2291/101; B23K 1/0056

(57) ABSTRACT

Systems and methods for repairing a surface defect in a metallic substrate can have a transducer that generates acoustic energy and an acoustic energy coupling tool connected to the transducer. The acoustic energy coupling tool receives the acoustic energy from the transducer and oscillates at a frequency corresponding to a frequency of the acoustic energy. A filler material is provided within the surface defect and the oscillation of the acoustic energy coupling tool causes a deforming impact of the acoustic energy coupling tool with the filler material within the surface defect, such that the filler material conforms to at least a portion of an internal surface of the surface defect. Additionally, the acoustic energy coupling tool is used to irradiate the filler material while it is being deformed with the acoustic energy.

### CROSS-REFERENCE TO RELATED APPLICATIONS

This application claims priority to U.S. Provisional Patent Application Ser. No. 62/821,228, filed Mar. 20, 2019, the entirety of which is herein incorporated by reference.

### TECHNICAL FIELD

The presently disclosed subject matter relates in some embodiments to methods and systems for repairing surface defects (e.g., surface cracks) in metallic structures or components.

### BACKGROUND

During service or during manufacturing, surface defects (e.g., most commonly in the form of surface cracks) often form on the surface of metallic components, often due to cyclic loading thereof during use. If not repaired, such surface cracks will inevitably spread and/or grow. It is well known that the presence of surface cracks in metallic structures or components, whether caused due to metal fatigue or otherwise due to some acute cause, such as physical damage from an impact, can, and ultimately will if not timely repaired, result in catastrophic failure of such metallic components. Several techniques exist at present to repair such cracks, including fusion welding methods like Tungsten Inert Gas (TIG) welding. These processes use heat energy, usually generated by an electric arc, to melt filler material and fill the crack. Other, more recent, repair methods, including laser direct metal deposition (LDMD), Laser Engineered Net Shape (LENS), and Cold Spray techniques, have also been used for repairing surface cracks in metallic components.

All such known repair processes utilize heat energy to create a melt pool of the provided filler metal at the location of the crack. After the filler material has been melted and the melt-pool has infiltrated the crack, the filler material rapidly solidifies to permanently fill the surface crack, thereby repairing the surface crack. The heat energy that enables melt-pool formation, however, also results in a large heat-affected zone in the undamaged portion of the metallic component near (e.g., adjacent to and/or in the immediate vicinity of) the repaired region. The presence of this heat-affected zone alters the microstructure of the metal of the metallic component itself in the repaired region. This heat-affected zone can result in the metallic structure having different physical properties in the repaired region than elsewhere in the metallic component, which can cause the repaired metallic component to have different characteristics from a metallic component that has not undergone crack repair. As such, a need exists for new methods and systems for repairing a surface defect in a metallic substrate or component without generating a significant amount of heat within the metallic component during the repair process.

### SUMMARY

To prevent such heat-induced changes in microstructure of the metallic component adjacent the repaired region, methods and systems using acoustic energy to deform and deposit voxels of a filler material within such surface defects are disclosed. The methods and systems disclosed herein eliminate the aforementioned issues in the final product associated with thermal history and solidification induced during such known repair methods and systems. The methods and systems disclosed herein utilize a solid state, room temperature technique in which high-frequency, small amplitude local shear strain is used to achieve energy-efficient volumetric conformation of a metallic filler material (e.g., a wire-shaped filament) within such a surface defect. Once the surface defect is filled, such methods and systems induce metallurgical bonding between the filler material and the metallic substrate at the surface of the surface defect at which the filler material makes contact and/or to which the filler material conforms.

This two-fold effect is similar in effect to what heating and melting a filler metal does, but in the new methods and systems disclosed herein, no heat is applied to either the filler material or the metallic substrate, and both the filler material and the surface of the surface defect remain solid (e.g., remain substantially at room temperature) throughout the time when the surface defect is being repaired. Additionally, the use of high-frequency, small amplitude oscillatory shear strain softens the filler material, allowing the filler material to “flow” into, and conform to, the internal surfaces and contours of such surface defects to which the filler material is applied. The methods and systems disclosed herein are further advantageous over the prior art, in that they are highly energy efficient compared with presently known fusion welding or laser-based techniques noted hereinabove. Additionally, the methods and systems disclosed herein eliminate safety and health hazards presented by melt-fusion based repair processes known according to the prior art.

The methods and systems disclosed herein also enable large-scale materials exchange (e.g., in the form of inter-metallic diffusion) at the interface between the filler material and the internal surfaces of the surface defect, thereby enabling metallurgical bonding between the filler material and the metallic component being repaired at the bondline formed. Since the methods and system use no heat energy and causes negligible temperature rise (e.g., less than about 10° C., or at least a temperature rise that does not cause a change in the microstructure of the metallic component), the microstructure of the metal of the substrate in the vicinity of the repaired region remains unaffected by the repair process. The methods and systems disclosed herein can be used to repair metallic substrates, structures, components, and the like in any of a wide variety of industries, including, for example, aerospace, maritime, automotive, and even including small-scale fabrication endeavors.

The methods and systems disclosed herein use two solid-state physical phenomena that result from the interaction of metals with high frequency acoustic energy. According to the first phenomena, acoustic energy causes metal to soften, resulting in lower stresses required during deformation of the filler material. According to the second phenomena, acoustic energy results in inter-metallic diffusion, causing bonding of the deformed filler material to the inner surface or contours of the surface defect against which the filler material is applied. The first phenomenon of softening causes the deformed metal to conform to the shape of the surface defect (e.g., a crack), while, according to the second phenomena, acoustic energy-enabled diffusion causes bonding of the filler material to the internal surfaces of the surface defect, thereby permanently filling the surface defect. Both of these solid-state physical phenomena induce only a negligible rise in temperature of the metal being repaired and no supplemental or auxiliary heat energy is applied during the repair process. The elimination of the use of heat energy results in a substantially unaltered microstructure of the metal in region(s) of the metallic substrate that have been repaired.

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this summary does not list or suggest all possible combinations of such features.

According to an example embodiment, a system for repairing a surface defect in a metallic substrate is provided, the system comprising: a transducer configured to generate acoustic energy; and an acoustic energy coupling tool connected to the transducer and configured to receive the acoustic energy from the transducer; wherein the acoustic energy coupling tool is configured for oscillatory movement at a frequency corresponding to a frequency of the acoustic energy generated by the transducer to deform a filler material that is positioned in and/or over the surface defect and underneath the acoustic energy coupling tool, the acoustic energy coupling tool being configured such that the oscillatory movement thereof conforms the filler material to at least a portion of an internal surface of the surface defect; and wherein the acoustic energy coupling tool is configured to irradiate the filler material with the acoustic energy at a same time as when the filler material is being conformed to at least the portion of the internal surface of the surface defect by the acoustic energy coupling tool.

In some embodiments of the system, the acoustic energy coupling tool is configured, by irradiating the filler material with the acoustic energy, to cause the filler material to soften and causes inter-metallic diffusion between the filler material and one or more internal surfaces of the surface defect against which the filler material is conformed by the acoustic energy coupling tool, thereby bonding the filler material to the substrate within the surface defect.

In some embodiments of the system, the acoustic energy coupling tool is movable, relative to the metallic substrate, to deposit the filler material as one or more successive layers formed within the surface defect to repair the surface defect and produce a repaired region of the metallic substrate that has a microstructure that is integrated with the microstructure of the metallic substrate.

In some embodiments, the system comprises a horn that couples the transducer to the acoustic energy coupling tool, the acoustic energy being transmitted from the transducer to the acoustic energy coupling tool via the horn.

In some embodiments of the system, the filler material is a filament having a generally annular cross-sectional shape.

In some embodiments of the system, the filler material and the metallic substrate comprise a same metal or metal alloy.

In some embodiments of the system, oscillating the acoustic energy coupling tool to deform and irradiate the filler material induces no heat gain, or negligible heat gain, in the filler material and/or the metallic substrate.

In some embodiments of the system, a microstructure of the metallic substrate is substantially unaltered during repair of the surface defect.

In some embodiments of the system, a frequency and/or amplitude of acoustic energy and/or a placement of the filler material within the surface defect is selected to minimize voids within a repaired region of the metallic substrate.

In some embodiments of the system, the acoustic energy coupling tool has a hardness greater than a hardness of the filler material and/or the metallic substrate. According to another example embodiment, a method of repairing a surface defect in a metallic substrate is provided, the method comprising: coupling a transducer to an acoustic energy coupling tool; arranging the acoustic energy coupling tool over a portion of the surface defect to be repaired; feeding a filler material underneath the acoustic energy coupling tool and/or at least partially within the surface defect; generating acoustic energy via the transducer to cause an oscillatory movement of the acoustic energy coupling tool at a frequency corresponding to a frequency of the acoustic energy generated by the transducer; impacting the filler material positioned underneath the acoustic energy coupling tool and/or at least partially within the surface defect with the acoustic energy coupling tool to deform the filler material so that the filler material conforms to at least a portion of an internal surface of the surface defect; irradiating the filler material with the acoustic energy at a same time as when the filler material is being deformed to conform to at least the portion of the internal surface of the surface defect by the acoustic energy coupling tool; and filling at least a portion of the surface defect with the filler material.

In some embodiments of the method, irradiating the filler material with the acoustic energy causes the filler material to soften and causes inter-metallic diffusion between the filler material and one or more internal surfaces of the surface defect against which the filler material is conformed by the acoustic energy coupling tool, thereby bonding the filler material to the substrate within the surface defect.

In some embodiments, the method comprises moving the acoustic energy coupling tool relative to the metallic substrate to deposit the filler material as one or more successive layers formed within the surface defect to repair the surface defect and produce a repaired region of the metallic substrate that has a microstructure that is integrated with the microstructure of the metallic substrate.

In some embodiments, the method comprises coupling the transducer to the acoustic energy coupling tool via a horn and transmitting the acoustic energy from the transducer to the acoustic energy coupling tool via the horn.

In some embodiments of the method, the filler material has a generally annular cross-sectional shape.

In some embodiments of the method, the filler material and the metallic substrate comprise a same metal or metal alloy.

In some embodiments of the method, the oscillatory movement of the acoustic energy coupling tool that causes the acoustic energy coupling tool to impact the filler material to deform and irradiate the filler material within the surface defect induces no heat gain, or negligible heat gain, in the filler material and/or the metallic substrate.

In some embodiments of the method, a microstructure of the metallic substrate is substantially unaltered during repair of the surface defect.

In some embodiments of the method, a frequency and/or amplitude of acoustic energy and/or a placement of the filler material within the surface defect is selected to minimize voids within a repaired region of the metallic substrate.

In some embodiments of the method, the acoustic energy coupling tool has a hardness greater than a hardness of the filler material and/or the metallic substrate.

### BRIEF DESCRIPTION OF THE FIGURES

FIG. 1 shows an exemplary embodiment of a system of the presently disclosed subject matter for using acoustic energy to repair a crack in the surface of a metallic component.

FIG. 2A is a top view of the exemplary embodiment of the acoustic energy coupling tool shown in the system of FIG. 1.

FIGS. 2B and 2C show exemplary dimensions of the acoustic energy coupling tool shown in the system of FIG. 1.

FIG. 3A is a cross-sectional view of a substrate with an artificially created surface crack formed therein.

FIG. 3B is a cross-sectional Scanning Electron Microscopy (SEM) image of the surface crack after the repair process is completed.

FIG. 3C is a detailed cross-sectional view of the region indicated in FIG. 3B, showing the microstructure of the metal at the interface between the substrate and the repaired region.

FIGS. 4A and 4B are respective cross-sectional views of two repaired samples having voids in the repaired region.

### DETAILED DESCRIPTION

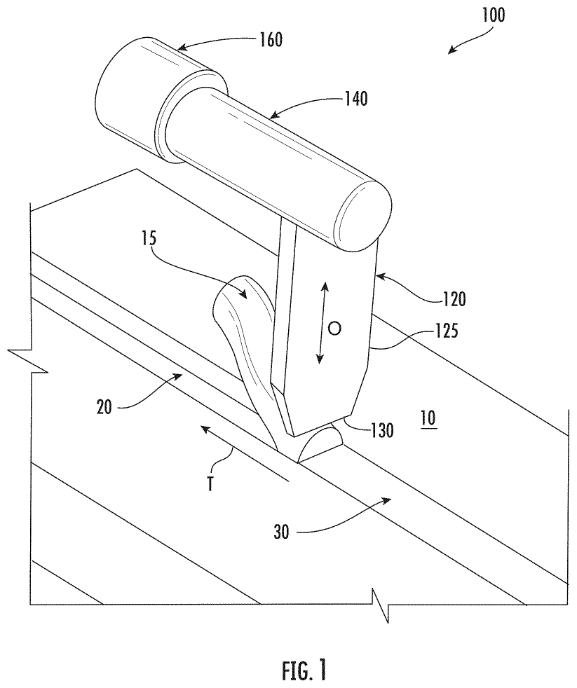

The presently disclosed subject matter relates to methods and systems for using acoustic energy to repair a surface crack in a metallic component without the need to apply heat energy to the metallic component during the repair. FIG. 1 shows an example embodiment of a system, generally designated 100, for applying acoustic energy to repair a crack, generally designated 20, in the surface of a substrate 10, such as the metallic component shown therein. In the example embodiment shown, the system 100 comprises an acoustic energy coupling tool 120 that is connected, via a stainless steel horn 140 in the embodiment shown, to a piezo-electric transducer 160 that vibrates at, at least in this example embodiment, a 60 KHz frequency, or otherwise produces ultrasonic acoustic energy. In some other embodiments, different excitation frequencies may be generated by the transducer 160 and transferred to the acoustic energy coupling tool 120, whether or not via a horn 140. In any such embodiments, the particular excitation frequency is based on the material being used as the filler material 15, the material of the substrate (e.g., substrate 10) being repaired, or any other considerations, without deviating from the scope of the disclosure herein. Similarly, different materials for the horn 140 and different types of transducers 160 from the example embodiments disclosed herein may be used without deviating from the scope of the present disclosure.

The method of using the system to repair a surface crack in a metallic substrate comprises positioning the acoustic energy coupling tool 120 over the surface crack 20, for example, by attaching the acoustic energy coupling tool 120 to a desktop gantry platform. The transducer 160 is energized at a specified frequency, 60 KHz in the example embodiment disclosed herein, and the oscillations of the transducer 160 are transmitted in the form of acoustic energy to the acoustic energy coupling tool 120 via the horn 140. A filler material 15, which is a filament feed made of solid aluminum in the example embodiment shown and described herein, is fed under the vibrating acoustic energy coupling tool 120. While other cross-sectional shapes for the filler material 15 may be used in other embodiments, the un-deformed filament of the filler material 15 has a generally annular cross-sectional shape in the embodiment shown.

The acoustic energy coupling tool 120 moves, as a result of the vibrations at the excitation frequency from the transducer 160, in a substantially vertical direction, generally designated O, to compress the filler material 15 within the surface crack 20 and, simultaneously, irradiates (e.g., transmits) acoustic energy at the excitation frequency into the filler material 15 as the filler material 15 is being compressed within the surface crack 20 to fill the surface crack 20. In some embodiments, the filler material 15 is therefore deformed by the oscillatory movements of the acoustic energy coupling tool 120 to have a shape that is substantially similar to the cross-sectional shape of the surface crack 20. In some embodiments, the surface crack 20 may have a cross-sectional area that is larger than a cross-sectional area of the filler material 15, in which case it is generally advantageous to apply multiple consecutive layers of the filler material 15 within the surface crack 20, until the filler material 15 within the surface crack 20 has substantially a same height as the outer edges of the surface crack 20 that define an outer surface of the metallic substrate 10.

The irradiation of the filler material 15 with acoustic energy via the acoustic energy coupling tool 120 causes the portion of the filler material 15 directly under the tip of the acoustic energy coupling tool 120 to soften, thereby simultaneously causing the filler material to conform to the shape of the surface crack 20 due to the vertical compression and/or lateral expansion of the filler material 15 within the surface crack 20 caused by the vertical motion of the acoustic energy coupling tool 120. At the same time, by using the acoustic energy coupling tool 120 to irradiate the filler material 15 with the acoustic energy as the filler material 15 is compressed within the surface crack 20, inter-metallic diffusion occurs between the substrate 10, at the internal surfaces and/or contours of the surface crack, and the filler material 15, thereby bonding the deformed filler material 15 to the internal surfaces of the surface crack 20 against which the filler material 15 is being compressively applied. This results in a voxel of the filler material 15 being deposited within and/or on the crack surface 20.

The steps of the method are repeated until a “run” of the filler material 15 is deposited over the entire length, or a portion thereof, of the surface crack 20. Several such “runs” can be deposited sequentially on top of each other, as necessary based on the depth of the surface crack 20, to completely fill up the surface crack 20. It has been observed that the acoustic energy density of 493.61 J/m³ provides the best conformance and bonding of the filler material 15 to the shape of the inner surface of the surface crack 20 in the example embodiment shown in FIG. 1.

It is advantageous for the acoustic energy coupling tool 120 to have a comparatively sharp tip, such that a width of the surface of the tip that makes contact with the filler material 15 is smaller (e.g., narrower) than the size (e.g., the width, which can be measured, for example, at the base or at the outer surface of the surface crack 20) of the surface crack 20 being repaired, so that the acoustic energy coupling tool 120 is able to adequately compress the filler material 15 within the surface crack 20 to substantially entirely fill the surface crack 20, so that the substrate 10 will have a same thickness (e.g., allowing for process tolerance variations) in the repaired region 30 as in the immediately adjacent portions of the substrate 10.

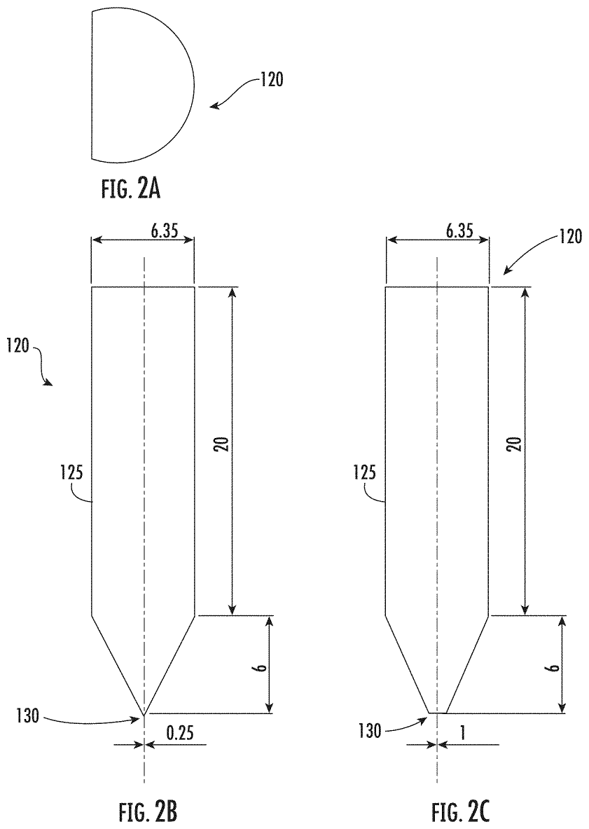

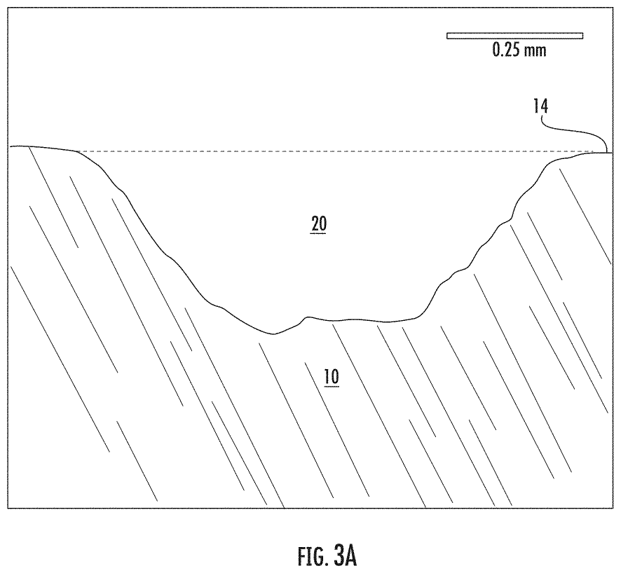

FIGS. 2A-2C show a top view and exemplary dimensions of an example embodiment of the acoustic energy coupling tool 120 suitable for use in repairing a surface crack 20 in a substrate 10, for example, in a substrate 10 made of aluminum using a filler material 15 made of aluminum. The acoustic energy coupling tool 120 has a body 125 that is a generally longitudinally extending member with a D-shaped cross-sectional area that tapers in a generally conically-shaped manner to a pointed tip, generally designated 130. The tip 125 physically impacts and compresses the filler material 15 within the surface crack and/or irradiates the filler material 15 such that the filler material 15 conforms to, and bonds with, the internal surfaces and/or contours of the surface crack 20. In the embodiment shown, the width of the body 125 is greater (e.g., wider) than a depth of the tapering portion that defines the tip 130. The disclosed geometry of the tip 130 is advantageous in that it is capable of inducing sufficient compression in the filler material 15, while at the same time also allowing for the tip 130 to reach and/or access smaller features.

To validate the suitability of the methods and systems disclosed herein in repairing surface cracks 20 in a substrate 10 in the form of a metallic component, empirical testing was performed. Surface cracks were formed in the substrates 10 formed from one or more aluminum plates and a solid aluminum filament was used as the filler material 15. During the testing, the piezo transducer 160 was connected to the acoustic energy coupling tool 120 by the stainless steel horn 140 and energized to produce an oscillatory vibration and/or movement at 60 KHz, such that the acoustic energy coupling tool 120 oscillated at a substantially similar frequency (e.g., at about 60 KHz). Oscillation of the acoustic energy coupling tool 120 can be in the axial (e.g., vertical) and/or lateral (e.g., horizontal) directions of the acoustic energy coupling tool 120, or in combinations thereof, but in plane with the filler material 15 and the substrate 10 workpiece (e.g., aligned with the direction of extension of the surface crack). The filler material 15, in the form of a solid aluminum filament, is progressively fed into and/or directly on top of (e.g., over) the surface crack 20 and under the tip 130 of the acoustic energy coupling tool 120, which irradiates the filler material 15 with the acoustic energy generated by the piezo transducer to compress the filler material 15 into the surface crack 20 and also to promote inter-metallic diffusion between the filler material 15 and the inner surface of the surface crack 20, thereby bonding the filler material 15 with the internal surfaces of the surface crack 20 (e.g., to the substrate) to fill, at least partially, the surface crack 20 and form the repaired region 30.

In some embodiments, the substrate 10 having the surface crack 20 can be held in a fixed position while the acoustic energy coupling tool 120 moves in the direction T along the length of the surface crack 20 to compress and/or bond the filler material 15 within and along the length of the surface crack 20. The movement and vertical position of the acoustic energy coupling tool 120 can be fully or partially automated or, in some embodiments, can even be manually controlled (e.g., configured to be hand-held by a user, or otherwise capable of being manually controlled). In some other embodiments, the acoustic energy coupling tool 120 can be held stationary while the substrate having the surface crack is mobile (e.g., movable) thereunder. Any combination of mobile/stationary components of the system 100 is contemplated.

To determine that no microstructure change occurred in the vicinity of the repair of the surface crack, Electron Backscatter Diffraction (EBSD) analysis was performed in the repaired region 30 of the surface crack 20 to validate the methods and systems disclosed herein.

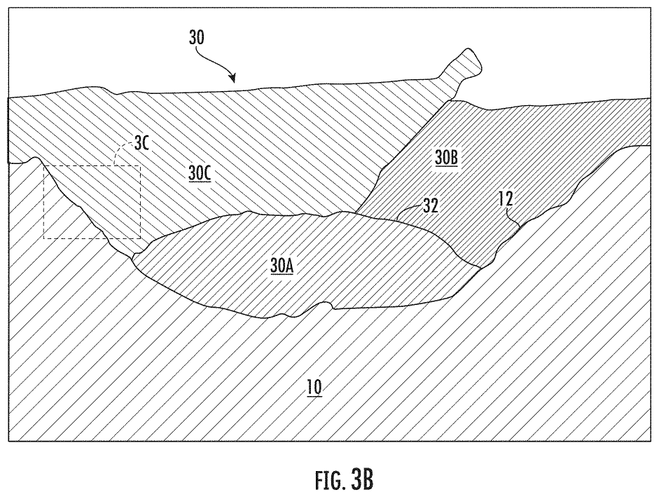

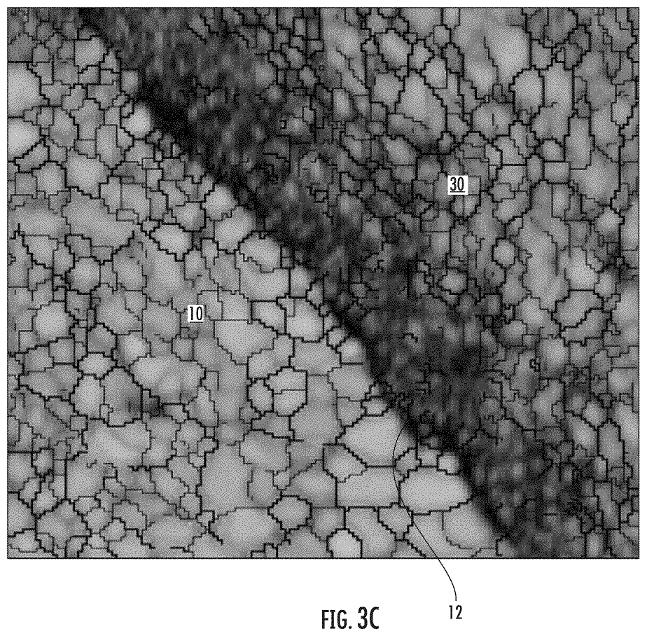

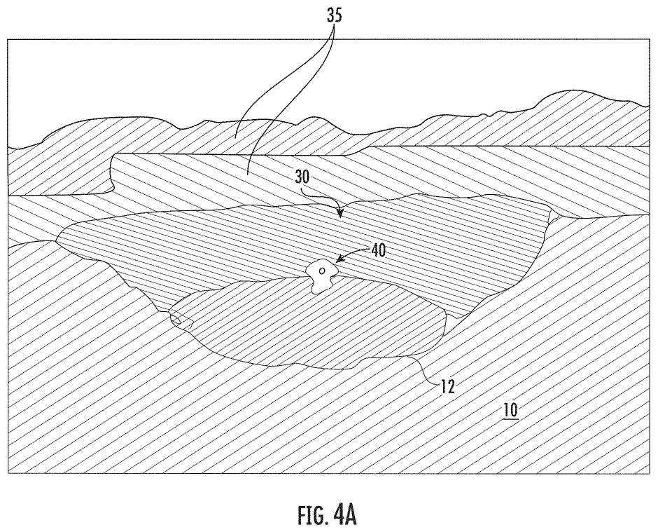

In FIG. 3A, an optical image of the cross-section of a substrate 10 made of aluminum with an artificially-created surface crack 20 formed therein is shown. The upper bounds of the surface crack 20 are shown schematically by the broken line connecting the outer edges of the substrate 10 on opposite sides of the surface crack 10. To repair this surface crack 20, the method was utilized three times to successively deposit the filler material 15, in the form of an aluminum filament, within the surface crack 20 to form three discrete layers of material (e.g., a first layer 30A, then a second layer 30B, then a third layer 30C) within the surface crack 20 to completely fill the surface crack 20. The result of this successive deposition method of the filler material 15 within the surface crack 20 completely fills the previously-defined surface crack 20 with the same material (e.g., aluminum) as the material of the substrate 10 (e.g., aluminum).

The filler material 15 and the substrate 10 may be a metal, metal alloy, or any suitable material. FIG. 3B shows a Scanning Electron Microscopy (SEM) image of a cross-sectional view of the repaired sample, as described herein with respect to FIG. 3A. The three successively deposited layers (30A, 30B, 30C) of the filler material 15 define a repaired region (e.g., 30, FIG. 1) and can be discerned upon close inspection, yet it is clearly visible from the image that the filler material 15 is deformed, such that the filler material 15 conforms to the shape of the inner surface 12 of the surface crack 20. As discussed elsewhere herein, the acoustic softening phenomenon aids in softening the filler material 15, which can be in the form of a wire, so that the filler material 15 conforms to the internal shape and/or contours of the surface crack 20. FIG. 3C is a detailed view of the area indicated in FIG. 3B, showing the microstructure of the substrate 10 and filler material 15 at the inner surface 12 of the surface crack 20, where an interface (e.g., bondline) between the substrate 10 and the filler material 15 is formed at the repaired region 30. As shown, the metallic microstructure of the substrate 10 at and/or adjacent to the interface between the substrate 10 and the filler material 15 does not show any appreciable change after the repair has been completed, relative to the metallic microstructure of the substrate 10 away from the interface between the substrate 10 and the filler material 15, according to the methods and systems disclosed herein. The unaltered microstructure of the substrate 10 at the interface between the substrate 10 and the filler material 15 provides a significant advantage over the heat energy-based surface repair processes currently known and utilized in the prior art.

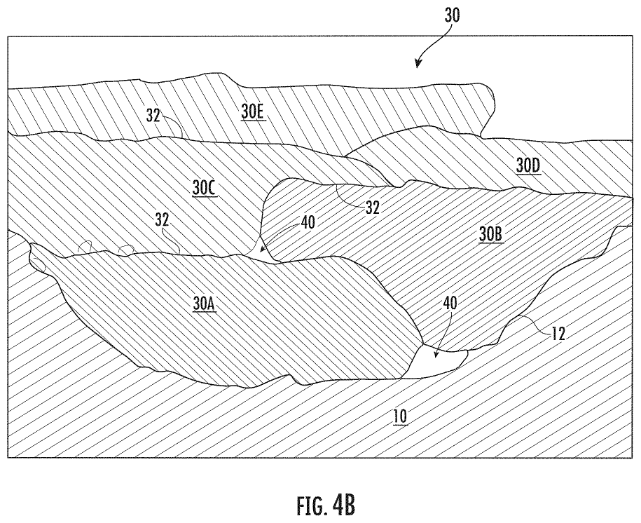

In FIG. 4A, a plurality of layers of filler material have been successively deposited to fill the surface crack, thereby defining a repaired region 30. In this embodiment, a plurality of external layers 35 are applied successively over the outer surface of both the substrate 10 and the repaired region 30. One or more of these external layers 35 can be provided and may cover only the repaired region 30, all of the repaired region 30 and a portion of the substrate 10 that is immediately adjacent (e.g., extending 50% or less of the width of the surface crack 20) to the surface crack 20, or over substantially all of (e.g., at least 75%, at least 90%, at least 95%, or at least 99%) the outer surface of the substrate 10. FIG. 4B shows an example embodiment in which five layers (30A through 30E) of filler material have been successively deposited. The layers 30A through 30E contact each other at boundary lines 32 and/or the substrate 10 at the inner surface 12 thereof.

FIGS. 4A and 4B also show examples of repaired substrates 10 that have voids 40 (e.g., air pockets, or regions in which the deformed filler material 15 is not present) in the repaired region 30 of the substrate 10. These voids are a result of improper positioning of the filler material 15 and/or acoustic energy density from the piezo transducer 160. These voids 40 result in a repaired region 30 that is weaker than would otherwise be anticipated of a repaired substrate and can result in premature material failure. Through proper application of the methods and use of such systems, it is possible to minimize, if not entirely eliminate, the presence of such undesirable voids in the repaired region 30 of the substrate 10.

Examples of applications in which the methods and systems disclosed herein may be implemented include, by way of non-limiting example, a machine that can perform surface repairs on metal components; a robotic arm with a surface repair tool head based on the methods and system disclosed herein to perform in-place/in-situ repair of components in service; a method and corresponding machine or system that uses surface vibrations to both detect surface defects and then repair the defects detected; and a method and corresponding machine or system that controls the microstructure of the metal at the interface between the filler material and the metallic substrate within the repaired region by varying the amount of vibratory shear strain energy applied during the repair.

While the subject matter has been described herein with reference to specific aspects, features, and illustrative embodiments, it will be appreciated that the utility of the subject matter is not thus limited, but rather extends to and encompasses numerous other variations, modifications and alternative embodiments, as will suggest themselves to those of ordinary skill in the field of the present subject matter, based on the disclosure herein. For example, such barriers may be used as an enclosure for patios, driveways, driveway entrances, fences, docks, and the like.

Various combinations and sub-combinations of the structures and features described herein are contemplated and will be apparent to a skilled person having knowledge of this disclosure. Any of the various features and elements as disclosed herein can be combined with one or more other disclosed features and elements unless indicated to the contrary herein. Correspondingly, the subject matter as hereinafter claimed is intended to be broadly construed and interpreted, as including all such variations, modifications and alternative embodiments, within its scope and including equivalents of the claims.

1. A system for repairing a surface defect in a metallic substrate, the system comprising:
a transducer configured to generate acoustic energy; and
an acoustic energy coupling tool connected to the transducer and configured to receive the acoustic energy from the transducer;
wherein the acoustic energy coupling tool is configured for oscillatory movement at a frequency corresponding to a frequency of the acoustic energy generated by the transducer to deform a filler material that is positioned in and/or over the surface defect and underneath the acoustic energy coupling tool, the acoustic energy coupling tool being configured such that the oscillatory movement thereof conforms the filler material to at least a portion of an internal surface of the surface defect; and
wherein the acoustic energy coupling tool is configured to irradiate the filler material with the acoustic energy at a same time as when the filler material is being conformed to at least the portion of the internal surface of the surface defect by the acoustic energy coupling tool.

2. The system of claim 1, wherein the acoustic energy coupling tool is configured, by irradiating the filler material with the acoustic energy, to cause the filler material to soften and causes inter-metallic diffusion between the filler material and one or more internal surfaces of the surface defect against which the filler material is conformed by the acoustic energy coupling tool, thereby bonding the filler material to the substrate within the surface defect.

3. The system of claim 1, wherein the acoustic energy coupling tool is movable, relative to the metallic substrate, to deposit the filler material as one or more successive layers formed within the surface defect to repair the surface defect and produce a repaired region of the metallic substrate that has a microstructure that is integrated with the microstructure of the metallic substrate.

4. The system of claim 1, comprising a horn that couples the transducer to the acoustic energy coupling tool, the acoustic energy being transmitted from the transducer to the acoustic energy coupling tool via the horn.

5. The system of claim 1, wherein the filler material is a filament having a generally annular cross-sectional shape.

6. The system of claim 1, wherein the filler material and the metallic substrate comprise a same metal or metal alloy.

7. The system of claim 1, wherein oscillating the acoustic energy coupling tool to deform and irradiate the filler material induces no heat gain, or negligible heat gain, in the filler material and/or the metallic substrate.

8. The system of claim 7, wherein a microstructure of the metallic substrate is substantially unaltered during repair of the surface defect.

9. The system of claim 1, wherein a frequency and/or amplitude of acoustic energy and/or a placement of the filler material within the surface defect is selected to minimize voids within a repaired region of the metallic substrate.

10. The system of claim 1, wherein the acoustic energy coupling tool has a hardness greater than a hardness of the filler material and/or the metallic substrate.

11. A method of repairing a surface defect in a metallic substrate, the method comprising:
coupling a transducer to an acoustic energy coupling tool;
arranging the acoustic energy coupling tool over a portion of the surface defect to be repaired;
feeding a filler material underneath the acoustic energy coupling tool and/or at least partially within the surface defect;
generating acoustic energy via the transducer to cause an oscillatory movement of the acoustic energy coupling tool at a frequency corresponding to a frequency of the acoustic energy generated by the transducer;
impacting the filler material positioned underneath the acoustic energy coupling tool and/or at least partially within the surface defect with the acoustic energy coupling tool to deform the filler material so that the filler material conforms to at least a portion of an internal surface of the surface defect;
irradiating the filler material with the acoustic energy at a same time as when the filler material is being deformed to conform to at least the portion of the internal surface of the surface defect by the acoustic energy coupling tool; and
filling at least a portion of the surface defect with the filler material.

12. The method of claim 11, wherein irradiating the filler material with the acoustic energy causes the filler material to soften and causes inter-metallic diffusion between the filler material and one or more internal surfaces of the surface defect against which the filler material is conformed by the acoustic energy coupling tool, thereby bonding the filler material to the substrate within the surface defect.

13. The method of claim 11, comprising moving the acoustic energy coupling tool relative to the metallic substrate to deposit the filler material as one or more successive layers formed within the surface defect to repair the surface defect and produce a repaired region of the metallic substrate that has a microstructure that is integrated with the microstructure of the metallic substrate.

14. The method of claim 11, comprising coupling the transducer to the acoustic energy coupling tool via a horn and transmitting the acoustic energy from the transducer to the acoustic energy coupling tool via the horn.

15. The method of claim 11, wherein the filler material has a generally annular cross-sectional shape.

16. The method of claim 11, wherein the filler material and the metallic substrate comprise a same metal or metal alloy.

17. The method of claim 11, wherein the oscillatory movement of the acoustic energy coupling tool that causes the acoustic energy coupling tool to impact the filler material to deform and irradiate the filler material within the surface defect induces no heat gain, or negligible heat gain, in the filler material and/or the metallic substrate.

18. The method of claim 17, wherein a microstructure of the metallic substrate is substantially unaltered during repair of the surface defect.

19. The method of claim 11, wherein a frequency and/or amplitude of acoustic energy and/or a placement of the filler material within the surface defect is selected to minimize voids within a repaired region of the metallic substrate.

20. The method of claim 11, wherein the acoustic energy coupling tool has a hardness greater than a hardness of the filler material and/or the metallic substrate.
